(19) United States
(12) Patent Application Publication
(10) Pub. No.: US 2016/0358261 A1
(43) Pub. Date: Dec. 8, 2016

(54) AUTOMATED TRADING SYSTEM FOR ROUTING AND MATCHING ORDERS

(71) Applicant: Chicago Board Options Exchange, Incorporated, Chicago, IL (US)

(72) Inventors: Edward T. Tilly, Barrington, IL (US); Anthony Montesano, Chicago, IL (US); Eileen C. Smith, Chicago, IL (US)

(73) Assignee: Chicago Board Options Exchange, Incorporated, Chicago, IL (US)

(21) Appl. No.: 14/991,688

(22) Filed: Jan. 8, 2016

Related U.S. Application Data
(63) Continuation of application No. 13/163,167, filed on Jun. 17, 2011, now abandoned.
(60) Provisional application No. 61/356,399, filed on Jun. 18, 2010.

(51) Int. Cl. G06Q 40/06

(52) U.S. Cl. CPC G06Q 40/06

(57) ABSTRACT

An automated system for routing orders in an exchange configured for trading securities or derivatives is disclosed. The system includes an electronic trade engine operative to receive an order from an originating firm, the order including a designation specifying a preference for a particular market maker for a security or derivative at the exchange. Upon determining that the order cannot trade at the exchange, the electronic trade engine, via an order handling system, is operative to route the order to a second exchange with a second designation that is one of: identical to the designation of the received order or modified to a different designation according to predetermined instructions.

### CROSS-REFERENCE TO RELATED APPLICATIONS

This application is a continuation of U.S. patent application Ser. No. 13/163,167, filed Jun. 17, 2011, pending, which claims the benefit of U.S. Provisional Application No. 61/356,399, filed Jun. 18, 2010, wherein the entirety of each is hereby incorporated herein by reference.

### TECHNICAL FIELD

The present disclosure relates to the trading of securities or derivatives, such as options or futures. More particularly, the present disclosure relates to an automated exchange trading system and method for routing and matching orders.

### BACKGROUND

The introduction of electronic trading mechanisms into exchanges for securities and derivatives has been an ongoing process. The desire for immediacy of order execution and dissemination of information is one reason for the steady substitution to electronic mechanisms. As trading volume continues to grow, along with the accompanying need for an increasingly efficient trading environment, the move toward electronic trading mechanisms is favored.

Electronic exchanges, while efficient and nearly instantaneous, do not necessarily provide for the routing of orders to a trade engine for a “flash” to the virtual crowd (an electronic, non-floor-based crowd) instead of routing to an away exchange with a more attractive market. A flash period is an auction period prior to the order linking away to another exchange. It is desirable for an exchange to provide a mechanism for the routing of orders to a trade engine for a “flash” to the virtual crowd instead of routing to a public automated routing (PAR) system for booking or automatically linking to an away market.

Currently, national best bid or offer (NBBO) rejects, certain “tweeners” and orders that are marketable against away markets route to PAR. Once on PAR, the orders are represented to the open outcry crowd and, if not traded by the crowd, are either routed to the book (“tweeners”) or to an away market. Since manual handling is required on a floor of an exchange for these orders and multiple orders may arrive at a single floor-based workstation, there can be delays between the time the order arrives on the floor-based workstation (e.g. public automated routing workstation (PAR)) and the time the order is routed, booked or sent away for linkage to an away market. During the time period when an order rests on PAR, there is risk to both the customer and the PAR broker.

### BRIEF SUMMARY

In order to address certain drawbacks of both traditional open outcry exchanges and electronic exchanges as they pertain to the trading of certain types of orders, an automated trading platform is disclosed herein for routing orders from a virtual trading crowd in an exchange according to predetermined instructions.

According to an aspect of the disclosure, an automated system for routing orders in an exchange configured for trading securities or derivatives is disclosed including an electronic trade engine operative to receive an order from an originating firm, where the order includes a designation specifying a preference for a particular market maker for a security or derivative at the exchange. The system may also include an electronic book in communication with the electronic trade engine that is operative to store at least one order or quote received by the electronic trade engine, as well as a database comprising predetermined instructions from the originating firm for modifying the designation associated with the order based on at least an alternative destination exchange. The database may be in communication with the electronic trade engine. The system may also include an order handling system in communication with the database. The order handling system may be operative to route the order to the alternative destination exchange, wherein the designation of the routed order is one of: identical to the designation of the order received at the electronic trade engine; or modified according to the predetermined instructions prior to routing the order.

### BRIEF DESCRIPTION OF THE DRAWINGS

For the purpose of facilitating an understanding of the subject matter sought to be protected, there is illustrated in the accompanying drawings an embodiment thereof, from an inspection of which, when considered in connection with the following description, the subject matter sought to be protected, its construction and operation, and many of its advantages should be readily understood and appreciated.

FIG. 1 is a diagram of one embodiment of an automated exchange system.

FIG. 2 is a block diagram of one embodiment of the electronic trading engine of FIG. 1.

FIG. 3 is a flow diagram of one embodiment of a method for providing order routing to a virtual crowd in an automated trading system.

### DETAILED DESCRIPTION OF THE DRAWINGS

A system and method for trading securities, such as securities options is described herein. The trading mechanisms and rules described are based on providing incentives or limitations to particular classes of individuals or entities who are involved in trading at an exchange. For purposes of this specification, the following definitions will be used:

Broker/dealer—person or entity registered to trade for itself and/or on behalf of others at the exchange.

Public customer—person or entity, who is not a broker/dealer, trading on their own behalf through a broker/dealer or firm registered to trade at the exchange.

Firm—entity employing persons who represent the firm, or the firm's customers, on the exchange, such as market makers, floor brokers, broker/dealers, or other industry professionals.

Market maker—professional trader registered to trade at the exchange who is required to provide liquidity to a market, for example through streaming quotes for both a bid and an offer at a particular price.

Designated primary market maker (DPM)—market maker designated by the exchange to be responsible for a fair and orderly market, and to provide continuous quotes, for a particular class of options.

Virtual crowd—an electronic, non-floor-based crowd.

Remote market maker (RMM)—a market maker not physically present on the floor of an exchange.

Market participant—any person or entity that can submit orders or quotes to an exchange.

Class of options—all series of options related to a given underlying security, where the underlying security may be, for example, publicly traded stock of a company.

Tweener—Order on a trading system that is represented to the open outcry crowd and, if not traded by the crowd, which is routed to the book.

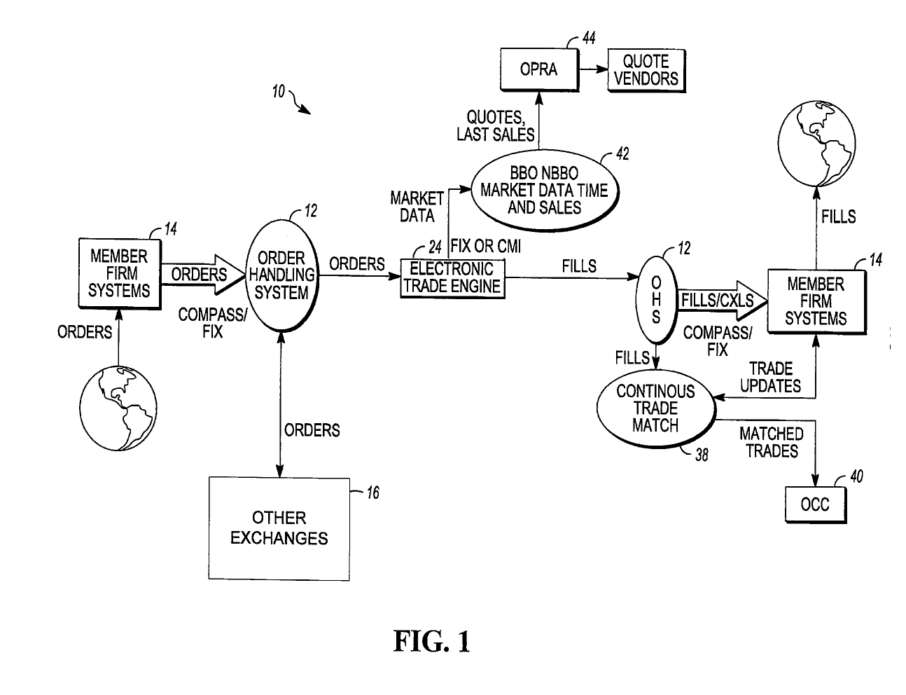

Referring to FIG. 1, one embodiment of an exchange system combining aspects of electronic, screen-based trading with traditional, open-outcry trading suitable for implementing various securities and derivatives trading methods described herein is illustrated. The exchange system 10 receives order information for the purchase or sale of securities, for example derivatives such as stock options, from numerous sources at a central order handling system (OHS) 12. OHS 12 may be any of a number of data processing systems or platforms capable of managing multiple transactions, as are well known in the art. For example, in one embodiment, the order routing system can be implemented on a transaction processing facility (TPF) platform manufactured by IBM Corporation. For purposes of clarity, the examples herein will refer specifically to options. However, it will be appreciated that the system and methods disclosed herein might be applied to the trading of other types of securities and derivatives.

Accordingly, an exchange utilizing the system and methods described herein may manage a number of classes of derivatives, where each of the plurality of classes of derivatives are associated with an underlying asset such as a stock, a bond, a note, a future, an exchange traded fund, an index, a commodity or other known asset types.

Information, such as orders may be entered into the OHS 12 from remote member firm systems 14 (including remote market makers 18) and/or other exchange systems 16. The member firm systems 14 and other exchange systems 16 may be located remotely from the geographical location of the exchange and use any of a number of standard landline or wireless communication networks to direct orders electronically to the OHS 12. The member firm systems 14 and other exchange systems 16 communicate with one of several interfaces or protocols for transmitting their orders to the OHS 12. Examples of suitable interfaces are those using a distributed object interface based on the Common Object Request Broker Architecture (CORBA) standard and available from the Object Management Group. Interfaces such as financial information exchange (FIX), which is a message-based protocol implemented over TCP/IP available from FIX Protocol, Ltd., or other known securities transaction communication protocols are also suitable protocols. Potential destinations for these orders are the OHS 12 or the electronic trade engine 24 in communication with the OHS 12.

When a trade is completed, such as a trade that is automatically executed through the electronic trade engine 24, the fill information is sent through the electronic trade engine 24 and OHS 12. OHS 12 passes the fill information to the member firm systems and to a continuous trade match (CTM) system 38 which matches the buy side and sell side of a trade which, in turn, forwards the matched trades to the Options Clearing Corporation (OCC) 40, a third party organization that will verify that all trades properly clear. The electronic trade engine 24 also sends quote and sale update information through an internal distribution system 42 that will refresh display screens within the exchange system 10 and format the information for submission to a quote dissemination service such as the Options Price Reporting Authority (OPRA) 44.

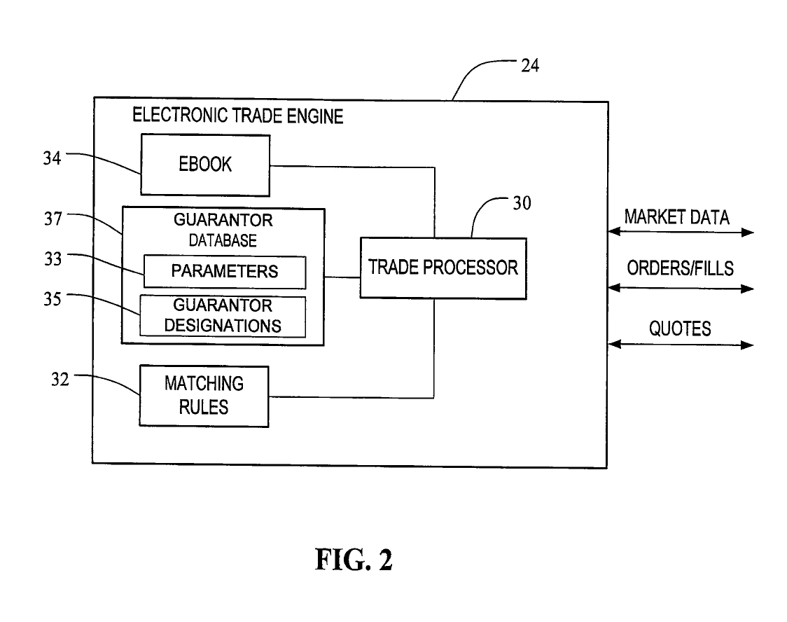

As illustrated in FIG. 2, an electronic trade engine 24 comprises a trade processor 30 that analyzes and manipulates orders according to matching rules 32 stored in the database in communication with the trade processor 30, as described in copending U.S. patent application Ser. No. 10/423,201, the entirety of which is hereby incorporated by reference. Also included in the electronic trade engine is the electronic book (EBOOK) 34 of orders and quotes with which incoming orders to buy or sell are matched with quotes and orders resting on the EBOOK 34 according to the matching rules 32. In an embodiment, upon a match, the electronic trade engine 24 will mark the matched order or quote with the broker-specific identifier so that the broker sending the order or quote information can be identified. The electronic trade engine 24 may be a stand-alone or distributed computer system. Any of a number of hardware and software combinations configured to execute the trading methods described below may be used for the electronic trade engine 24. In one embodiment, the electronic trade engine 24 may be a server cluster consisting of servers available from Sun Microsystems, Inc., Fujitsu Ltd. or other known computer equipment manufacturers. The EBOOK 34 portion of the electronic trade engine 24 may be implemented with Oracle database software and may reside on one or more of the servers comprising the electronic trade engine 24. The rules database 32 may be C++ or java-based programming accessible by, or executable by, the trade processor 30.

When a trade is automatically executed through the electronic trade engine 24, the fill information is sent through the electronic trade engine 24 and OHS 12. OHS 12 passes the fill information to the member firm systems and to a continuous trade match (CTM) system 38 which matches the buy side and sell side of a trade which, in turn, forwards the matched trades to The Options Clearing Corporation (OCC) 40, a third party organization that will verify that all trades properly clear. The electronic trade engine 24 also sends quote and sale update information through an internal distribution system 42 that will refresh display screens within the exchange system 10 and format the information for submission to a quote dissemination service such as the Options Price Reporting Authority (OPRA) 44.

The exchange system 10 may be configured to incorporate quote trigger functionality to permit greater participation in trades. The quote trigger would automatically be invoked when a new better price is entered so that additional market participants may have a limited time in which to enter quotes at a price matching the new better price and obtain a portion of the order. For example, upon detecting a quote from a market participant at a new best price which would match against an order on the electronic book from a non-ICM, the electronic trade engine 24 will remove the quantity of the resting order that would be tradeable against the incoming quote and hold it and the incoming quote for a predetermined period of time. Any desired preset hold period may be used, however in one embodiment it is contemplated that a five second hold period is used. In other embodiments, the hold period may be fixed anywhere in the range of 0.5-5.0 seconds. After removing the quantity of the resting order, the electronic trade engine 24 will treat the removed quantity of resting order as having been sold and disseminate a last sale market data message so that the OPRA system 44 will indicate the trade has taken place. The electronic trade engine 24 will update the top-of-the-market (i.e. update the quote) as though the trade had immediately occurred.

During the hold period, any other quotes or orders from market participants that would also be marketable against the original resting order are gathered and the resting order volume at the current best price will be further reduced, if any still remains in the book. At the expiration of the hold period, the accumulated in-crowd market participant quotes and orders are traded against the resting orders. If the size of the resting order was greater than the size of the sum of the market participant quotes and orders, each of the quotes and orders would execute fully against the resting order. If the size of the resting order is less than the sum of the market participant quotes and orders, the resting order is allocated among the quotes and orders according to the matching algorithms discussed above. The electronic trade engine will then send fill reports of the executed trades to the OHS 12 for distribution to the appropriate source of the quotes or orders involved.

NBBO Rejects

If an incoming order is marketable, but the exchange is not the NBBO, the OHS 12 will utilize routing parameters that permit NBBO reject orders to route to the electronic trade engine 24 on a class and origin basis. NBBO reject orders that are routed to the electronic trade engine 24 will be handled as described below.

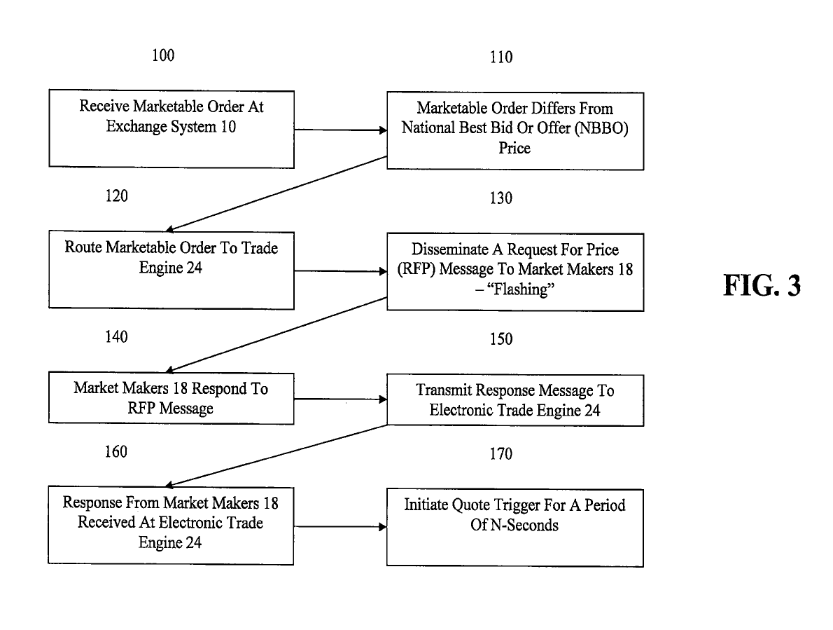

Referring now to FIG. 3, a method of providing orders to a virtual trading crowd in an exchange prior to automatically linking the order to an away market is illustrated. As shown, a marketable order (an order that is marketable at an away market) for a security or derivative is received at the exchange system 10 (step 100), the exchange system 10 having a price for the security or derivative that differs from a national best bid or offer price. The marketable order is routed to the trade engine 24 (step 120), where a Request for Price (“RFP”) message is disseminated (“flashing,” as detailed below) to a plurality of remote market makers 18 quoting a class (step 130), which as detailed below, can include information such as the starting (and trading) price, as well as the side and size of the order. At least one of the remote market makers 18 responds to the RFP message (step 140) and transmits a response message to the electronic trade engine 24 (step 150). The response message, which is a message indicating the remote market makers' 18 response to the RFP message, is received at the electronic trade engine 24 (step160), and a quote trigger is initiated, with the quote trigger occurring for a period of N seconds (step 170).

In accordance with an embodiment, any existing quote locks, quote triggers or auctions for quotes and offers at the NBBO will end and will be allocated prior to the start of any “flashing” of NBBO reject orders to market makers quoting in the class. In one embodiment, “flashing” is accomplished by transmitting a Request for Price (“RFP”) to the market makers quoting in the class. The system 10 may retain a record of all market makers quoting at the best price as well as the firm quote obligation when the RFP is sent. This is referred to as the “flash” phase. In one embodiment, the RFP includes the NBBO price as the starting (and trading) price, as well as the side and size of the order. The flash phase will last for a period of N second(s), where N may be a fixed or variable time period, or until the first RFP response is received, whichever is shorter. Typically, the flash phase period is the same for any flash type described herein. In one embodiment, the N-second period is less than 5 seconds. In other embodiments, it is contemplated that each flash type (e.g. NBBO reject, Tweener, etc.) may be assigned a different time period. In yet other embodiments, the time period may be variable based on the current number of market makers in the quoting class, the number of contracts involved or other instantaneous or historical statistic relating to the class of options being traded.

Unlike other RFPs, the NBBO price is not a starting price for an auction. Instead, the NBBO is typically the price that the order will be traded at even if a quote moves to a better price or an RFP response is received at a better price. Essentially, the order is treated as though it has been booked at the NBBO price. As with other RFP responses, these will not be displayed as part of the disseminated quote. Once the first response is received from a market maker at the appropriate price (either a quote, or an ICM order, also referred to as an I-order or an RFP response) the second phase (the “trigger” phase) will be started. During the trigger phase, a quote trigger will last for N seconds. In one embodiment, a last sale price will be disseminated immediately. Quotes, I-orders and RFP responses may be included in the quote trigger group.

In one embodiment, the order will be allocated using a matching algorithm, referred to herein as the Capped Ultimate Matching Algorithm (CUMA). In CUMA, the allocation algorithm will typically be configurable by class and/or by auction-type. For example, matching algorithms can be used to allocate an incoming order to participants based on the number of participants and the order size each participant represents. Furthermore, orders are preferably allocated to the multiple market participants quoting at the same price based on two components: an ‘A’ component, or parity factor, and a ‘B’ component, or pro rata/depth of liquidity factor. The parity factor of the matching algorithm treats as equal all market participants quoting at the relevant best bid or offer at the exchange (BBO). Thus, if there were four market participants quoting or bidding at the best price, each would be assigned 25 percent for the parity component of the matching algorithm. Viewed in conjunction with the pro rata factor of the algorithm, the parity component of the algorithm provides incentive to market participants to quote at a better price than their competitors even though they may have a smaller quote size than other market participants quoting at the BBO.

The second component of CUMA rewards those quoting larger sizes at the best price by providing the market participants a pro rata component based on the percentage of the volume of that market participant's quote size with reference to the sum of the total of all quote sizes at the best price, with the added feature that certain participants are limited in the size of their order that will be used to calculate the ‘B’ component of the equation. For example, if the disseminated quote represents the quotes of market makers x, y, and z who quote for 20, 30, and 50 contracts respectively, then the percentages assigned under the pro rata component are 20% for x, 30% for y, and 50% for z. The final allocation may then be determined by multiplying the average of the A and B components by the size of the incoming order available. In one embodiment, the matching algorithm described above produces the following equation:

$$Participant ' s allocation = incoming order size x \\ [ \frac{\frac{1}{number of partcipants} + \frac{participant quote size}{Σ partcipant quote sizes}}{2} ]$$

Thus, for example, where certain participants are limited in the size of their order that will be used to calculate the ‘B’ component of the equation, participants such as in-crowd market makers (ICMs) may be capped in this way so that, after other participants have already entered their order or quotes, the ICM cannot inflate the size of its order to obtain a greater pro rata weighting (and thus greater allocation) of the available order.

Additionally, all responses (including quotes, I-orders and RFP responses) from a single market maker will typically be aggregated for the purposes of calculating the ‘A’ component of CUMA. A participation filter may be used by the trading engine to determine which market participants can or cannot participate in the quote trigger. For example, the electronic trade engine may be configured to permit all non-customers to participate in the quote trigger process by recognizing a participant identifier associated with non-customers. In other implementations the electronic trade engine may be programmed to only allow ICMs to participate in a quote trigger.

If non-customers were included in the quote trigger process based on this filtering mechanism, an incoming order under the ‘B’ component could start the quote trigger after the RFP period is started. Additionally, an incoming ‘B’ component of the order would participate in the quote trigger, rather than trading at the next price. It is anticipated that customers will continue to trade as they do today.

In another embodiment, the order will be allocated using another matching algorithm, referred to herein as the Maker-Taker Algorithm. Under the Maker-Taker Algorithm, all trades are divided into two types of orders: price setter and price taker. Traders who want to buy or sell at a given price place a price setter order, and traders who want to interact with the bid or offer place a price taker order. Often, the price setters receive a rebate when their orders are executed, while the price takers are charged for order execution. There is no customer priority of orders in connection with this algorithm.

Once the flash phase begins, if a marketable customer order is received that could trade against the flashed order, the orders will trade against each other immediately with any balance routing to the appropriate destination. If a customer order is received during the trigger phase, it may trade at the next available price or route to the appropriate destination.

If the away market moves during the flash phase and the exchange becomes the NBBO, the flash phase will end and the order will be automatically traded and allocated to the market makers on the quote. If an away market moves to a better price during the flash phase, the flash phase will end and the order will route for auto-linking to an away exchange. Since market makers may have a firm quote obligation during the N-second flash phase, if the exchange market makers move quotes such that there is no longer enough size to fill the incoming order up to the original disseminated size, the order will be routed to an away exchange immediately using auto-link functionality.

If the flash phase ends and there are no responses, the order will automatically link away from the exchange to another exchange. In the unlikely circumstance that the order cannot be routed away once it is received due to either: (1) a lack of an away market at a better price, or (2) the OHS 12 rejects that order because the away market is no longer available after the system 10 attempts to send the linkage order, the system 10 will automatically route the order back to the electronic trade engine 24 where it will be filled at the original firm quote price up to the original firm quote size.

In one embodiment, the order may be filled in one of the following ways:

If there are market makers on the market that can fulfill the firm quote obligation (the original price and size or better) the order will be assigned to them. Alternatively, if there is more size required to fulfill the firm quote obligation, the order will be assigned to those quoters who comprised the firm quote at the time the order was received. Since the electronic trade engine 24 will have to keep track of the participants that were on the original market, it is contemplated that an additional mechanism may be required so that the electronic trade engine 24 does not have to store the information indefinitely.

In one embodiment, a market maker guarantor may be designated to fill orders not fully executed (and therefore have a remaining portion). Such a designated market maker guarantor assures that there will be an NBBO execution for the remaining portion of orders from a submitting firm that are not fully executed after the exposure and allocation periods have concluded (detailed above). There may be one or more predetermined market maker guarantors and each market maker guarantor may set parameters 33 on their execution guarantees including but not limited to order size, price, size of a displayed national best bid or offer, which exchanges are displaying the national best bid or offer, transaction costs, and a number of increments from an exchange best bid or offer. Market maker guarantors may set only one or any combination of these parameters 33, which parameters 33 may then be stored in a database of the exchange system 10. The market maker guarantor designations 35, i.e. the market makers designated as guarantors, and the parameters 33 set by the market maker guarantors may both be stored in a guarantor database 37 in communication with the trade processor 30, as detailed herein above, so that the trade processor 30, in communication with both the rules database 32 and the guarantor database 37, can be operative to analyze and execute orders according to the allocation algorithm selected from the rules database 32 and allocate a remaining portion of the order, if any, to at least one predetermined market maker guarantor selected from the guarantor database 37 to execute the remaining portion of the order at the national best bid or offer price.

Preferably, the remaining portion of the order is automatically allocated to the market maker guarantor if the remaining portion meets the parameters 33 set by the market maker guarantor. A notification may be sent by the exchange system 10 to the market maker guarantor upon the automatic allocation of the remaining portion of the order. It is also contemplated that, in the event that the remaining portion of the order exceeds the order size that a market maker guarantor is willing to guarantee, the remaining portion of the order may be divided among more than one market maker guarantor so that the entire remaining portion may be executed at the NBBO. Alternatively, it may be desired that, if the remaining portion of the order exceeds the order size that a market maker guarantor is willing to guarantee, the remaining portion is not executed against the market maker guarantor.

“Tweener” Locks

An incoming order that is between the market at the exchange, but is marketable against an away market, is commonly referred to as a “tweener lock.” The “tweener lock” order cannot be booked because it would lock or cross an away market. In one embodiment, the OHS 12 comprises routing parameters to allow tweener locks to route to the electronic trade engine 24 based on class and origin. Orders that are routed to the electronic trade engine 24 will typically be handled as described above for NBBO rejects, with the exception that there is no firm quote obligation. Thus, the requirements of the firm quote will typically not be followed. If there are no responses during the flash phase, the order will be automatically linked away. If the order cannot be linked away, it will automatically route back to the electronic trade engine 24 for booking.

“Tweeners”

An incoming order that is between the market at the exchange and does not lock or cross an away market is commonly referred to as a “tweener.” In one embodiment, the OHS 12 comprises parameters used to route tweeners to the electronic trade engine 24 based on class and origin code. Orders that are routed to the electronic trade engine 24 will be handled as described above for NBBO rejects, with the exception that there is no firm quote obligation. Thus, the requirements of the firm quote will not be followed. If there are no responses during the flash phase, the order will typically be booked automatically.

Preferred Market-Makers

In yet another embodiment, the exchange may also adopt a Preferred Market-Maker structure and a participation entitlement for Preferred Market-Makers (PMMs). A PMM structure allows order senders to designate a preferred Market-Maker for orders sent to the exchange. If the PMM meets certain requirements at the time the order is received by the exchange, the PMM is entitled to an enhanced participation on the trade (a participation entitlement).

The Exchange may allow, on a class-by-class basis, for the receipt of orders that carry a designation specifying a Market-Maker in that class as the “Preferred Market-Maker” for that order. The PMM will receive a participation entitlement for such order if the certain provisions are met, including: (i) the PMM is registered in the relevant option class; and (ii) the PMM is quoting at the best bid/offer on the exchange. The participation entitlement shall be 40% when there are two or more Market-Makers also quoting at the NBBO on the exchange, and 50% when there is only one other Market-Maker quoting at the NBBO on the exchange. In addition: (i) a PMM may not be allocated a total quantity greater than the quantity that the PMM is quoting at the best bid/offer on the Exchange; (ii) the participation entitlement rate is based on the number of contracts remaining after all public customer orders in the book at the best bid/offer on the exchange have been satisfied; and (iii) if a Preferred Market-Maker receives a PMM participation entitlement, then no other participation entitlements shall apply to such order.

PMMs may be subject to heightened quoting requirements. More specifically, PMMs may be required to comply with the quoting obligations applicable under exchange rules and must provide continuous electronic quotes in at least 90% of the series of each class for which it receives Preferred Market-Maker orders.

The exchange may receive a marketable preferred order (an order that includes a designation specifying a particular market maker in that class as the “Preferred Market-Maker” for that order) which it does not execute, and then, using either the exchanges own broker/dealer or an unaffiliated broker/dealer, either a) passes the order through for execution elsewhere (e.g., to another exchange) at the posted NBBO along with the original designation of the preferred market maker for that order, or b) modifies the designation of the preferred market maker associated with the order based on the new destination exchange using pre-determined instructions by the originating firm (i.e. a data table, database or the like).

Although the system and methods described herein relate to an exclusively electronic, screen-based exchange that does not include floor based, open-outcry trading, many of the procedures described may be applied to a system incorporating and involving active participation from a trading floor and a screen-based electronic trading crowd. As will be appreciated by those of ordinary skill in the art, mechanisms for providing orders to a trading crowd in an exchange prior to booking the order or automatically linking the order to an away market and other features described above may all be modified for application to other forms of trading within the purview and scope of the present invention. An advantage of the disclosed system and methods is that more traders at the exchange may have more opportunity to see and compete for orders that are NBBO rejects, tweener locks or tweeners, thus increasing visibility of orders and the desirability of maintaining a presence at the exchange.

The matter set forth in the foregoing description and accompanying drawings is offered by way of illustration only and not as a limitation. While particular embodiments have been shown and described, it will be apparent to those skilled in the art that changes and modifications may be made without departing from the broader aspects of applicants' contribution. It is therefore intended that the foregoing detailed description be regarded as illustrative rather than limiting, and that it be understood that it is the following claims, including all equivalents, that are intended to define the scope of this invention.

1.-9. (canceled)

10. An automated exchange system for routing electronic orders comprising:
an electronic trade engine configured to receive an electronic order via an electronic communication network from a remotely located order generating system, the electronic order comprising an identifier designating an initial trading entity at the automated exchange system;
an electronic book in communication with the electronic trade engine, the electronic book operative to store at least one order or quote received by the electronic trade engine;
a database comprising predetermined instructions from the remotely located order generating system for modifying the identifier associated with the electronic order based on at least an alternative destination exchange, the database in communication with the electronic trade engine; and
an order handling system in communication with the database, the order handling system configured to, in response to a failure to execute the electronic order at the automated exchange:
modify the electronic order to replace the identifier of the electronic order with a new identifier, the new identifier comprising a new trading entity associated with a second automated exchange; and
route the modified electronic order away from the automated exchange and to the second automated exchange via the electronic communication network.
